(19) United States
(12) Patent Application Publication
(10) Pub. No.: US 2022/0344963 A1
(43) Pub. Date: Oct. 27, 2022

(54) SYSTEMS AND METHODS FOR HIGH POWER DC CHARGERS

(71) Applicant: Epirus, Inc., Hawthorne, CA (US)

(72) Inventors: Velimir Nedic, Los Angeles, CA (US); Harry Bourne Marr, Jr., Manhattan Beach, CA (US); William Griffin Dower, Torrance, CA (US); Denpol Kultran, Torrance, CA (US)

(21) Appl. No.: 17/659,812

(22) Filed: Apr. 19, 2022

Related U.S. Application Data
(60) Provisional application No. 63/177,947, filed on Apr. 21, 2021.

(51) Int. Cl. H02J 7/02; H02J 7/00; H02M 3/158; H02M 7/217

(52) U.S. Cl. CPC H02J 7/02; H02J 7/00712; H02J 7/00711; H02J 7/0047; H02M 3/158; H02M 7/217; H02J 2207/20; H02M 1/4208

(57) ABSTRACT

A high-power DC charger system and method to charge a battery or electric vehicle are disclosed. The system can include a high-power rectifier with a plurality of Gallium Nitride (GaN) switches and a plurality of silicon carbide (SiC) rectifying diodes. The rectifier can be configured to receive AC input and output DC voltage and a converter configured to convert the voltage from the rectifier into a DC voltage that meets the charging needs of a battery.

### CROSS-REFERENCE TO RELATED APPLICATIONS

This application claims priority to U.S. Provisional Patent Application No. 63/177,947 filed on Apr. 21, 2021, which is incorporated by reference in its entirety.

### TECHNICAL FIELD

This disclosure relates generally to high-power microwave systems and their use in high power charging applications.

### BACKGROUND

Direct current (DC) chargers can charge electric vehicles (EVs) at higher charging rates than AC chargers. For example, a Level 2, 7.2 kW AC charger can take about an hour to deliver about 27 miles of range for an EV, while a 50 kW DC charger can deliver the same range in about 10 minutes. A number of vehicle manufacturers are designing their cars to be capable of being charged by 100 kW and higher power DC chargers. Accordingly, there is a need for DC fast chargers that are capable of providing DC power greater than 100 kW with increased efficiency and reduced size/weight.

### SUMMARY

This disclosure provides systems and methods for fast charging solutions for electric or electromechanical systems, such as an electric vehicle configured to use direct current (or voltage). The electric vehicle may be any mode of transportation, for example, a bus or car or bike or truck etc. that operates using direct current (or voltage) or relies on battery power or charging requirements. The power charging systems and methods described herein can be configured to provide fast and efficient charging solutions to electric vehicles.

The systems and methods described herein are further directed towards managing and distributing power to one or more battery (or charging) systems on multiple platforms (e.g., on a fleet or convoy). Disclosed solutions can optimize the available power to fit within a power budget and optimize the power to maximize the overall system performance.

In various implementations, the systems and methods described herein provide an intelligent power management system (or power management system) that can monitor, control, and distribute power across (i) electric vehicle in multiple environments (e.g., power solutions to multiple vehicles in a convoy or fleet, etc.); (ii) electric vehicle in a singular environment (e.g., domestic power solutions for charging an electric vehicle); (iii) hardware command and control within a system and/or subsystem (e.g., to control various parts and components of an electric vehicle), or (iv) hardware command and control from a central system (e.g., portable device or hub).

In various implementations, the systems and methods described herein provide a direct current (DC) charging system. As used herein, DC can include at least one of direct current or direct voltage. The DC charging system can include an intelligent (or smart) power system, a charging circuit, and a battery system. The intelligent power system may include one or more of input/output systems, sensing systems, electronic processing systems, power adapting systems, or control systems. A charging circuit system may include a rectifier system (or rectifier), a power converter system (or power converter), a sensor system (or one or more sensors), switches, diodes, temperature controllers, power distributors, etc. The battery system may include cells (or batteries), switches, etc.

In various implementations, the rectifier system may comprise various circuitry arrangements that include one or more of Gallium Nitride (GaN) switches and silicon carbide (SiC) rectifying diodes. The rectifier system can be configured to receive AC input and provide DC output. The charging system can include a converter system configured to down convert the output of the rectifier system (such as, DC voltage) into a DC voltage (or current) that meets the charging needs of a battery.

In various implementations, the power management system is configured to control multiple circuits, switches, and/or sensors to monitor the power status (e.g., battery status or charging circuit status). In some implementations, the power management system can adaptively control the power distribution to adjust the output power (such as, DC) up or down to optimize the power output for “just the right amount” required by the vehicle or battery system.

In various implementations, the power management system is configured to control multiple circuits, switches, and operating conditions based on the power requirement and power consumption conditions associated with the battery system (or vehicle charging system) and regulate the power supply. The power requirement conditions may include one or more of the amount of power supply required to charge the batteries, number of batteries, type of batteries, type of vehicle (car or truck or bike, etc.), power storage capacity, battery charging time, temperature conditions, or other operating conditions, etc. Power consumption conditions may be, for example, the amount of power consumed by the type of vehicle, amount of storage power required to the batteries, and power consumed in a time frame (e.g., in an hour, a day, a week or month,), etc. In some cases, power requirement conditions may include conditions related to various components and sub-components of the vehicle or charging system. An example of various components can include vehicle motor, on-board charging components, air-conditioner (AC), heating system, battery, alternator, fan system, transmission system, etc. An example of various sub-components can be type of cells or batteries, dimensions or size of batteries, charging requirements to media or auxiliary system, etc.

The power management system can be configured to control various circuits, switches and operating conditions based on the profile associated with the vehicle or user. The power management system can adjust (or provide) the power supply to multiple components (or sub-components) of the electric vehicle or battery system based on the profile associated with the vehicle or user. The profile information can be a user profile or vehicle profile, or profile related to various component and/or sub-component, etc. An example of user profile can be type of user (vehicle owner, a student driver, frequent driver), usage of vehicle (hourly, monthly, quarterly, or yearly), number of miles driven, etc. An example of vehicle profile can be type of vehicle (car or bike or truck or other mode of transportation), number of batteries, power requirements, power consumption, power storage capacity, temperature parameters, etc. An example of various component and/or sub-component profile can be, information related to type of battery, power capacity of one or more batteries, power requirement to auxiliary or media system, power requirement to AC (or heating unit), power requirement to fan, etc.

In various implementations, the power management system can monitor and control or adjust the power supply (e.g., switching on and/or off) to one or more components and/or sub-components of a vehicle. For instance, the power management system can perform such adjustment or control in a timescale less than a millisecond (e.g., in a few microseconds or a few nanoseconds).

The power management system can be configured to control various circuits, switches, and/or sensors that monitor the real-time (e.g., within a few seconds, a few milliseconds, a few microseconds, etc.) environmental factors and other associated conditions and adjust the power supply to charge the batteries.

In various implementations, the power management system is configured to control various circuits, switches, and sensors that monitor the environmental and/or external conditions and adjust the power supply to various components and/or sub-components of the vehicle. For example, consider a user operating (or driving) an electric vehicle. The power management system can monitor the environmental conditions, such as, snow weather and/or external conditions, such as, traffic light, etc., and control the power supply by switching on/off the direct current (or voltage) supply to various components and/or sub-components. For example, this can include switching on or off the power supply or adjusting power supply to battery or media system or other auxiliary systems. Another example can be saving the power when it is not required to be used by various components and/or sub-components. For instance, when a user is operating an electric vehicle, the power management system monitors the external conditions, such as, traffic patterns on the road and/or traffic light and controls the flow of power to one or more components and/or subcomponents. Yet another example can be, based on the external conditions (e.g., traffic pattern or traffic signal), controlling the power supply operations of vehicle by controlling the amount of current supplied from battery to the drive train on the wheels (for instance, the current can be supplied in a microburst).

In some implementations, the power management system may be configured to control various circuits, switches, and sensors that can monitor the environmental conditions, external conditions, and behavioral patterns of the user to adjust and fine tune the power supply to various components and/or sub-components of the vehicles. An example of environmental conditions may include weather conditions (e.g., rain, snow, summer, wind, etc.), temperature, time of the day (e.g., morning, noon, night) etc. An example of external conditions may include traffic lights (e.g., green, yellow, or red), type of road surface (e.g., rough, desert road or hilly roads, etc.), type of vehicle (e.g., truck or car or motor bike or bus or trailer, etc.), driving speed (e.g., high speed or low speed or racing speed), traffic pattens (e.g., slow moving, fast paced traffic, etc.), etc. An example of behavioral conditions may include driving patterns of a user for example, drive time (e.g., average driving time on a day or week or month or year, etc.), driving speed (e.g., slow, high, moderate, or racing speed, etc.), usage of one or more components in car (e.g., motor, on-board charger system, electric power control unit, entertainment media, usage of auxiliary devices, heater and/or AC, air, etc. The power management system can monitor one or more above mentioned conditions to monitor and distribute the power supply to vehicle and/or to provide an efficient power storing solutions to the user.

In various implementations, a processor or controller (such as, CPU) is configured internally or externally to the power management system. The processor can be connected to a memory that stores instructions executed by the processor. The processor can execute instructions that implement artificial intelligence (AI) or machine learning (ML) to monitor, learn, and classify various conditions of the DC charging system. The various conditions may include environmental conditions, external conditions, and behavioral patterns of a user associated with the vehicle or battery profile, etc. The power management system can provide the power supply (or charging capacity) to one or more components and/or sub-components of the vehicle based on the one or more learned behaviors.

The processor can execute one or more AI or ML processes to monitor, learn, and classify the type of vehicles (e.g., truck or car or motor bike, year/make/model of vehicle), type of systems and/or sub-systems (type of motor, type of battery, size of battery, etc.). For example, the power management system can monitor, learn, and classify the profile of a battery, motor or auxiliary systems and can apply the power requirements (e.g., battery charging etc.) matching the type (or profile) of battery, motor or auxiliary system integrated in the type of vehicle. In some variations, using AI and/or ML, the power management system can monitor, learn, and classify the health of components and/or sub-components of a vehicle. An example can include monitoring the health status of a battery, identifying the health status with regards to the performance of battery and controlling the power level provided to the battery. Advantageously, monitoring the health status of components and/or sub-components and controlling the power requirements in devices, machines, and/or vehicles can be helpful to optimize the performance of the overall system.

In some implementations, the power management system can monitor the health status of one or more components and/or sub-components of the vehicle and can prioritize the supply of power based on the health status. For example, in a case where there are several batteries installed in a vehicle, the power management system can monitor the health (or battery profile) status of a subset (or each) battery the plurality of batteries. The power management system can accordingly prioritize to charge the weakest battery first in contrast to other batteries from the group. In some variations, the power management system can also monitor the material (or type) of battery (for example, Lithium-ion (Li-ion), nickel-metal hydride (NiMH), lead acid, or Silicon carbide (SiC)), and based on the type of battery adjust and tune the power supply. Therefore, the power management system can monitor to optimize the power supply to s subset (or each) battery to provide the efficient distribution of power (or charging capacity) to various component and/or sub-components of the vehicle.

In some implementations, the power management system controls various circuits, switches, and/or sensors to monitor, controls and distribute the power tailored to a battery profile. The battery profile may include type of battery (e.g., (Li-ion, NiMH, SiC, lead-acid, etc.), storage capacity of battery, charging time, overall size of the battery, temperature of battery, life span of battery, weight of battery, etc.

In some variations, the power management system controls one or more circuit and/or switches to control the amount of voltage or current required to charge the batteries. The power management system can intelligently control the timing for switching on and off the power circuits.

In various implementations, the power management system monitors and controls the flow of current and/or voltage flowing from the battery to one of more components and/or sub-components. The power management system can control the timing of switching on and off the power switches to adjust (or tune) the amount of generated direct current and/or voltage to charge the battery.

Some of the disclosed systems and methods provide fast and efficient power supply solutions using a transformer-less architecture. In various implementations, the power management system is configured to switch on and off the rectifier circuits to provide an efficient power supply to batteries. The power management system can be configured to control the switches to provide power supply to the battery at an adjustable level. For example, the power management system can control and provide the direct current supply to the battery in the range from 10V up to 10 kV based on battery profile mentioned above.

In some implementations, a power management system can be configured to provide a voltage or a current to one or more circuits that further comprises one or more high power amplifiers (HPAs) (which include switches). The power management system can include one or more of an electronic processing system, sensor system, a power adapting system configured to convert power received from an external power supply to voltage levels and/or current levels to turn on an amplifier connected to the power management system, a sensing system configured to sense a current from the amplifier, and a memory connected to the electronic processing system.

Embodiment 1: A direct current (DC) charging system configured to charge a battery, the system comprising:

a rectifier comprising:
a plurality of Gallium Nitride (GaN) switches; and
a plurality of silicon carbide (SiC) rectifying diodes,
wherein the rectifier is configured to receive alternative current (AC) input and output a first DC signal; and

a converter configured to convert the first DC signal into a second DC signal that meets charging needs of a battery, wherein the converter comprises a plurality of SiC switches, and wherein the second DC signal is provided to the battery for charging the battery.

Embodiment 2: The DC charging system of Embodiment 1, wherein the plurality of GaN switches are disposed in one or more locations of the rectifier configured to operate at a voltage equal to or below a voltage threshold, and wherein the plurality of SiC rectifying diodes are disposed in one or more locations of the rectifier configured to operate at a voltage above the voltage threshold.

Embodiment 3: The DC charging system of Embodiment 2, wherein the voltage threshold is between about 500V and about 700V.

Embodiment 4: The DC charging system of any of Embodiments 1 to 3, further comprising a DC bus connected to the rectifier and the converter.

Embodiment 5: The DC charging system of any of Embodiments 1 to 4, further comprising a power management system configured to interface with the rectifier and the converter, wherein the power management system is configured to sense at least one of currents or voltages at various portions of the plurality of GaN switches and adjust a plurality of signals configured to turn on or turn off the plurality of GaN switches based on the sensed at least one of currents or voltages.

Embodiment 6: The DC charging system of Embodiment 5, wherein the power management system is further configured to sense the at least one of currents or voltages at various portions of the plurality of SiC switches and adjust a plurality of signals configured to turn on or turn off the plurality of SiC switches based on the sensed at least one of currents or voltages.

Embodiment 7: The DC charging system of any of Embodiments 5 to 6, wherein the power management system comprise a pulse width modulation (PWM) generator and a processor configured to control the PWM generator to generate a plurality of driving signals to control the plurality of GaN switches.

Embodiment 8: The DC charging system of Embodiment 7, wherein the processor is configured to determine a tradeoff between a frequency and duty cycle of at least one driving signal of the plurality of driving signals to achieve a desired efficiency or a desired output DC voltage.

Embodiment 9: The DC charging system of Embodiment 8, wherein the power management system is configured cause the second DC signal to be adjusted based on an input from a user or an external computing system, wherein the second DC signal is adjusted as a result of adjusting the frequency or duty cycle of the at least one signal of the plurality of signals.

Embodiment 10: The DC charging system of Embodiment 9, wherein the input comprises one or more digital control signals.

Embodiment 11: The DC charging system of any of Embodiments 5 to 10, wherein the power management system is further configured to adjust switching frequencies of the plurality of SiC or GaN switches based on an output voltage required by the battery.

Embodiment 12: The DC charging system of any of Embodiments 5 to 11, wherein the power management system is further configured to monitor health of at least one of the plurality of GaN switches or the SiC switches.

Embodiment 13: The DC charging system of any of Embodiments 5 to 12, wherein the power management system is further configured to collect data related to health and operating status of at least one of the plurality of GaN switches or the SiC switches.

Embodiment 14: The DC charging system of any of Embodiments 1 to 13, wherein the converter is configured as a DC-DC converter.

Embodiment 15: The DC charging system of any of Embodiments 1 to 14, wherein the converter does not include a transformer.

Embodiment 16: The DC charging system of any of Embodiments 1 to 15, wherein the rectifier is configured to output the first DC signal between about 500V and about 1500V.

Embodiment 17: The DC charging system of any of Embodiments 1 to 16, wherein the converter is configured to output the second DC signal in a range between 50V and 10 kV to the battery.

Embodiment 18: A direct current (DC) charging system configured to charge a battery, the system comprising:

a rectifier comprising:
a plurality of Gallium Nitride (GaN) switches; and
a plurality of silicon carbide (SiC) rectifying diodes,
wherein the rectifier is configured to receive alternative current (AC) input and output a first DC signal;

a converter configured to convert the first DC signal into a second DC signal that meets charging needs of a battery, wherein the converter comprises a plurality of SiC switches; and

a power management system configured to monitor and control one or more operating conditions of at least one of the rectifier or converter.

Embodiment 19: The DC charging system of Embodiment 18, wherein the power management system is configured to monitor the one or more operating conditions and modulate supply voltage or current to at least one of the rectifier or converter.

Embodiment 20: The DC charging system of any of Embodiments 18 to 19, wherein the one or more operating conditions comprise at least one of: a temperature of at least one of the rectifier or converter, currents or voltages at various terminals of at least one the rectifier or converter, gate voltage of at least one GaN switch, timing of switching on and off the at least one GaN switch, or bias voltage provided to the at least one GaN switch.

Embodiment 21: The DC charging system of any of Embodiments 18 to 20, wherein the battery comprises at least a battery cell, a sensor, or a switch, and wherein the power management system is configured to monitor operating conditions of the battery and control supply of the second DC signal to the battery.

Embodiment 22: The DC charging system of Embodiment 21, wherein the operating conditions of the battery comprise power requirement conditions and power consumption conditions associated to the battery.

Embodiment 23: The DC charging system of Embodiment 22, wherein power requirement conditions comprise at least one of: an amount of power supply required to charge the battery, number of batteries in the battery, type of battery, type of vehicle powered by the battery, power storage capacity of the battery, battery charging time, or temperature condition.

Embodiment 24: The DC charging system of Embodiment 23, wherein power consumption conditions comprise at least one of: amount of power consumed by the type of vehicle, amount of storage power required by the battery, and power consumed by the battery over a period of time.

Embodiment 25: The DC charging system of any of Embodiments 18 to 24, wherein the power management system is further configured to control supply of the second DC signal to the battery based on a profile associated with at least one of a user, vehicle powered by the battery, or component of the vehicle.

Embodiment 26: The DC charging system of Embodiment 25, wherein the profile associated with the user comprises at least one of type of user, usage of vehicle by the user, or mileage driven by the user.

Embodiment 27: The DC charging system of any of Embodiments 25 to 26, wherein the profile associated with the vehicle profile comprises at least one of a type of vehicle, number of batteries integrated in the vehicle, power requirements, power consumption, power storage capacity, or temperature parameters of the vehicle.

Embodiment 28: The DC charging system of any of Embodiments 25 to 27, wherein the profile associated with the component of the vehicle comprises at least one of information related to type of battery, power capacity of one or more batteries, power requirement to auxiliary or media system, power requirement to air conditioning (AC) unit, power requirement to heating unit, or power requirement to fan.

Embodiment 29: The DC charging system of any of Embodiments 18 to 28, wherein the power management system is further configured to regulate supply of the second DC signal to the battery based on environmental factors comprising at least one of weather conditions, time of the day, traffic light pattern, road surface, driving speed, or traffic pattern.

Embodiment 30: The DC charging system of any of Embodiments 18 to 29, wherein the power management system is further configured to monitor a health status of one or more components of a vehicle powered by the battery and prioritize supply of the second DC signal based on the health status.

Embodiment 31: The DC charging system of any of Embodiments 18 to 30, wherein the power management system is configured to monitor a health status of the battery in a group of batteries and prioritize supply of the second DC signal based on the health status of the battery.

Methods of using any of the DC charging systems described herein are disclosed.

The systems, methods, modules, and devices of this disclosure each have several innovative aspects, no single one of which is solely responsible for the desirable attributes disclosed herein. A variety of example systems, modules, embodiments, and methods are provided herein below.

### BRIEF DESCRIPTION OF THE FIGURES

The disclosure is more fully appreciated in connection with the following detailed description taken in conjunction with the accompanying drawings, in which:

FIG. 1 illustrates an overview of a direct current (DC) charging system.

FIG. 2A illustrates an implementation of a DC fast charger with a DC-DC converter that steps down a DC voltage from a higher voltage to a lower voltage.

FIG. 2B is a schematic illustration of some components of the DC fast charger illustrated in FIG. 2A.

FIG. 2C schematically illustrates a fast energy storage device integrated with the implementation of the DC fast charger depicted in FIG. 2A.

FIG. 2D depicts an architecture to increase the DC power provided to a battery.

FIG. 3 illustrates simulation results for voltage and currents output from the implementation of the DC fast charger depicted in FIG. 2A.

Like reference numerals refer to corresponding parts throughout the several views of the drawings.

### DETAILED DESCRIPTION

### Overview

Innovative aspects of this disclosure include a fast direct current (DC) charger that can achieve overall power efficiencies over 95% (such as, at least 98%). Various implementations of the DC chargers (or DC charging devices or DC charging systems) described in this application can provide voltages from about 50V to 10 kV. The implementations of DC chargers described herein can include Gallium Nitride (GaN) switching devices that can switch, for instance, at frequencies between 75 kHz and about 1.5 MHz. The use of GaN switching devices can reduce the size of the passive components (e.g., inductors) thereby reducing the size and weight of the DC charging devices. Accordingly, implementations of DC chargers described herein can achieve power densities greater than or equal to 2 kW/liter (e.g., 5 kW/liter, 10 kw/liter or greater).

In some implementations, DC charging systems and methods disclosed herein can include a hybrid architecture utilizing GaN devices for voltages less than or equal to a voltage threshold and silicon carbide (SiC) devices for voltages greater than the voltage threshold. The voltage threshold can be between about 500V and about 700V, such as about 650V.

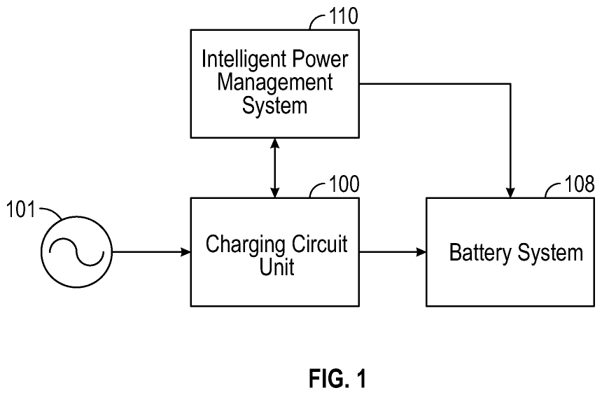

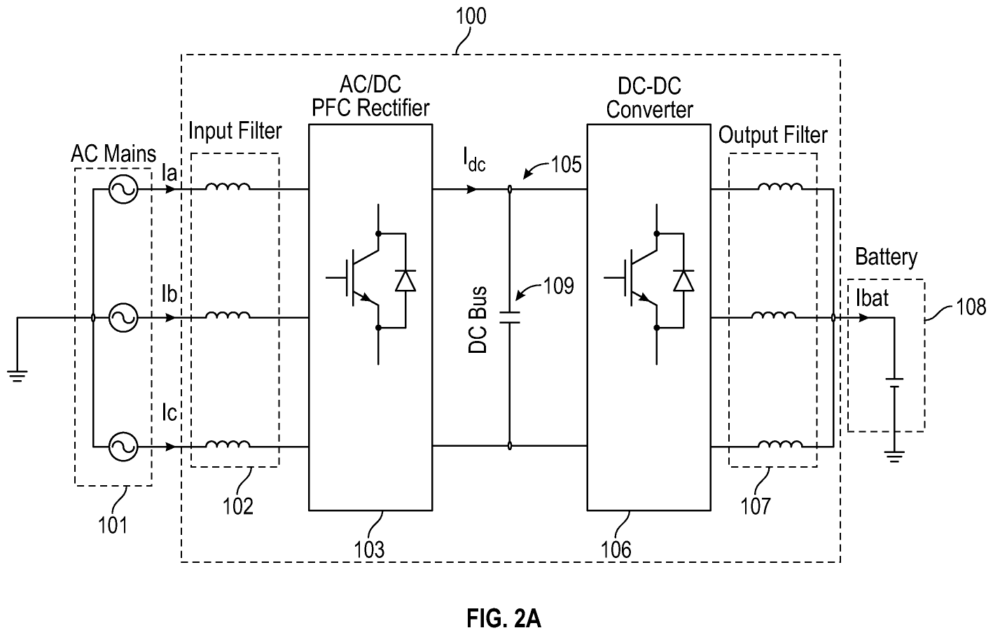

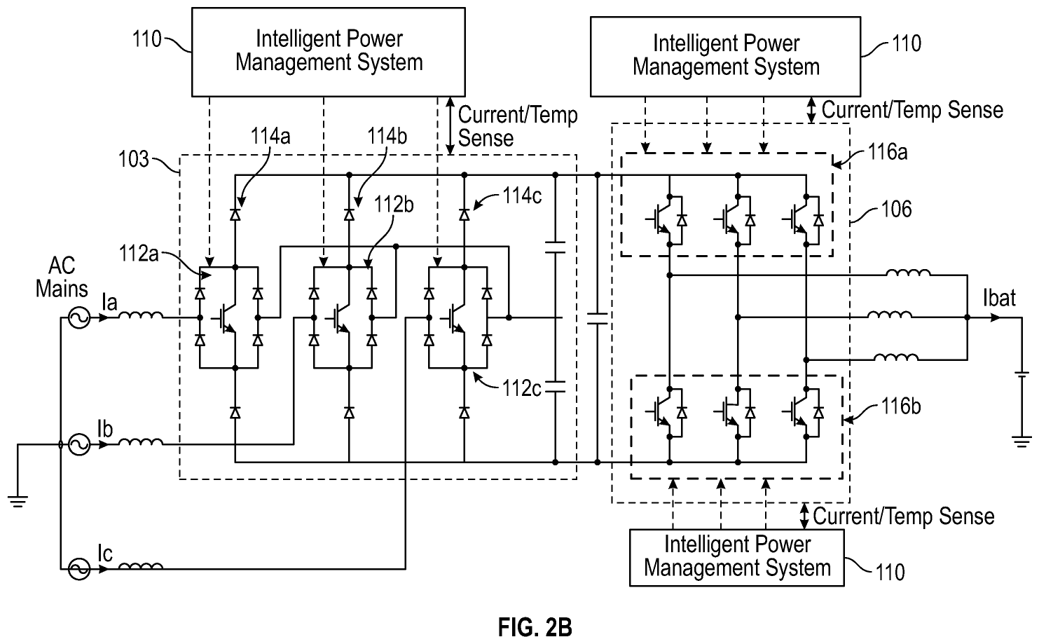

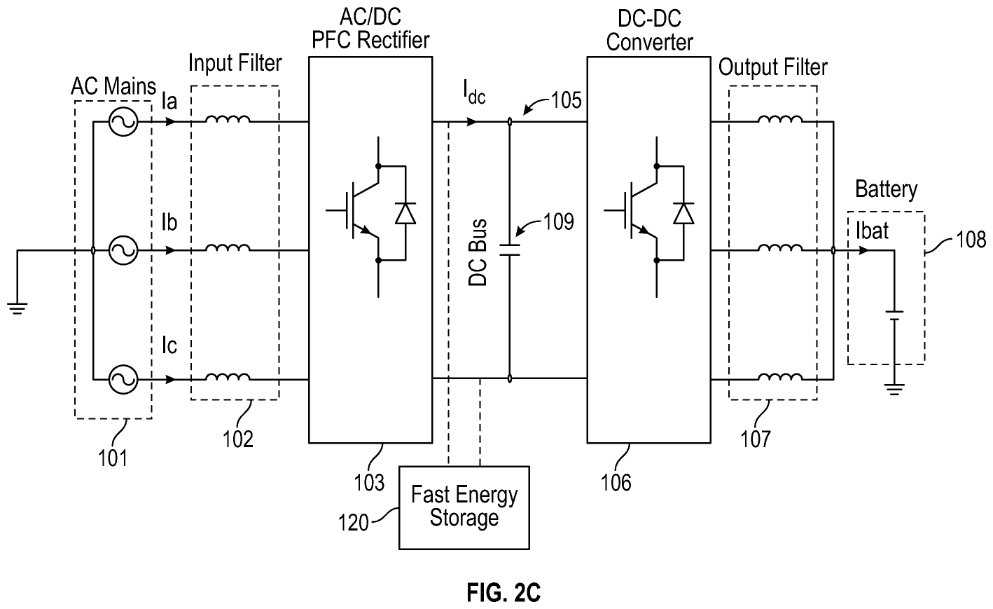

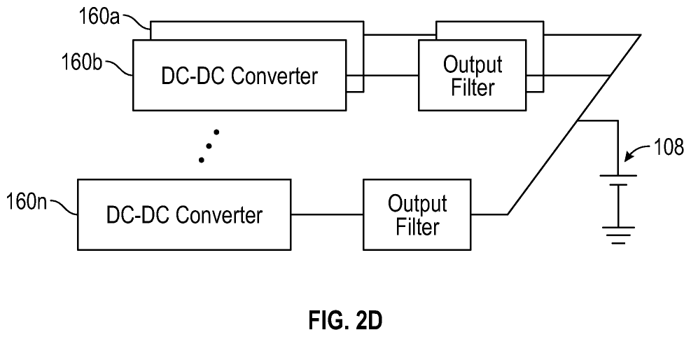

FIG. 1 illustrates an overview of a DC charging system. The charging system can include an alternating current (AC) main line (or mains) 101, a charging circuit unit 100 that receives power from the AC main line 101, an intelligent power management system 110 that controls the charging circuit unit 100, and a load, which can be a battery system (or battery) 108, that receives charging power from the charging circuit unit 100. The AC main line 101 can be a three-phase line that outputs AC voltage in various range, for example, 110V, 220V, 440V, etc. The details of the various components illustrated in FIG. 1 are further explained below, such as in connection with FIGS. 2A and 2B.

The intelligent power management system 110 can be configured to provide the required voltages and currents to efficiently operate at least one of the charging circuit unit 100 and battery system 108. In various implementations, the power management system 110 is configured to operate in response to a signal received from the charging circuit unit 100. For example, based on the AC input received from the AC mains 101, the charging circuit unit 100 sends a signal to the intelligent power management system 110. In response, the power management system 110 provides appropriate biasing voltages and/or currents to control the switching devices (or amplifiers) in the charging circuit unit 100. The power management system 110 can adjust or change the biasing voltages and/or currents to the amplifiers based on information obtained about input signal characteristics, output signal characteristics, system operating conditions (e.g., operating temperature, operating currents/voltages at various terminals of the amplifier/system, etc.), an input received from a user or an electronic processing system controlling the biasing systems, or information obtained from look-up tables that provide an understanding of the state of the one or more amplifiers. The power management system 110 can provide appropriate biasing voltages and/or currents to turn on the amplifiers. The power management system 110 can reduce the biasing voltages and/or currents to turn off the amplifiers in response to absence of signal to be amplified or a sensed characteristic (e.g., input signal power, output signal power, temperature, gate current/voltage, or drain current/voltage) being outside a range of values.

The power management system 110 is configured to monitor the operating conditions of the battery system 108 and adjust (or tune) the DC power to efficiently charge the battery system or an electric vehicle. Additional details of intelligent power management system 110, charging circuit system 100, and battery system 108 are further described below with the support of FIGS. 2-4.

In various implementations of the fast DC charging system described herein can be integrated with intelligent bias power management systems that can sense (i) currents and voltages at various portions of the switching devices; and/or (ii) temperature of the switching devices and adjust the bias voltages and/or currents provided to the switching devices in response to the sensed current/voltage and/or temperature.

The intelligent bias power management systems can control the switching frequencies of the switching devices to optimize the voltage output from the DC chargers to facilitate fast charging of electric vehicles or battery systems (e.g., in less than 15-20 minutes).

In various implementations, systems and methods described here use an ultra-compact and small footprint power charging system using a high electron mobile GaN hybrid architecture. The intelligent power management system can control the GaN charging architecture. In some variations, the GaN architecture described herein can operate at a charging rate up to 1MHz (or up to 1.5 MHz in some cases). Such design architecture can help in reducing the size of passives and filter magnetics by a factor of 20 (or more) versus existing pre-production units.

### Charging Systems

FIG. 2A illustrates an implementation of a scalable DC charging system that is capable of outputting DC voltages in the range from about 50V to about 10 kV with less than about 5% (such as, less than or equal to about 3%) total harmonic distortion (THD). The illustrated implementation comprises AC mains 101, input filter 102, AC/DC power factor correction (PFC) rectifier 103, DC bus 105, DC-DC converter 106, output filter 107, and battery 108. Input filter 102, AC/DC PFC rectifier 103, DC bus 105, DC-DC converter 106, and output filter 107 can be part of the charging circuit unit 100. The DC bus 105 can comprise a positive feed line and a negative return line. A capacitor 109 can be included between the positive feed line and the negative return line of the DC bus. The capacitor 109 can provide a path for the AC ripple current and/or filter the DC bus voltage. The DC-DC converter 106 can be configured to convert a first amount of DC voltage provided at the input of the DC-DC converter 106 to a second amount of DC voltage at the output of the DC-DC converter 106. For example, the DC-DC converter 106 can be configured to output a DC voltage between 50V and about 10 kV. The depicted DC charging system can be electronically controlled and configured to output a desired DC voltage based on instructions received from a user or a processor. In various implementations, the DC-DC converter 106 can be a non-isolated converter. In such implementations, the DC-DC converter 106 is not electrically isolated from the rectifier 103 by a transformer or some other system of providing electrical isolation.

The AC main line 101 can be a three-phase line that outputs AC voltage, for example 440V. The AC voltage can be applied to the charging circuit unit 100. The charging circuit unit 100 can include various components, such as, input filter 102, AC/DC rectifier 103 (which can be a PFC rectifier), DC bus 105, DC-DC converter 106, and output filter 107. The AC input voltage can be smoothed using an input filter 102 before being applied to AC/DC rectifier 103. The AC/DC rectifier 103 can be configured to receive AC voltage (or current) from AC main line 101, convert to DC voltage (or current), and provide DC voltage (or current) into a DC bus 105. In various implementations, the rectifier 103 can be configured to output DC voltage greater than or equal to 1100V (such as, up to 10 kV) into the DC bus 105. The charging system can further comprise a DC-DC converter 106 that can output 10 kW-400 kW of DC power to the battery 108. Depending on the current and voltage requirements of the battery 108, the converter 106 can output DC voltage in a range between 110V and 1000V. The DC-DC converter can be a transformer-less design which can advantageously reduce the size of the charger by an amount greater than or equal to about 30 cubic decimeters. The transformer-less design can also achieve overall power efficiencies greater than or equal to about 95%, such as, for example greater than or equal to 98% or more, as compared to existing DC chargers comprising a transformer. The DC charger can comprise an output filter 107 at the output of the DC-DC converter.

FIG. 2B schematically illustrates in detail the architecture of the AC/DC rectifier 103 and the DC-DC converter 106. The rectifier 103 can comprise a switching element (e.g., 112a, 112b, and 112c) and a rectifying diode (e.g., 114a, 114b, and 114c) for each of the phases of the three-phase AC line. The switching element (e.g., 112a, 112b, and 112c) can comprise GaN switches that are capable of switching at frequencies up to 1 MHz. The use of GaN switches can advantageously shrink the size of the passive components (e.g., inductors and filters) that, as described herein, can help in reducing the size and weight of the charger and achieve power density greater than 2 kW/liter. The rectifying diode (e.g., 114a, 114b, and 114c) can comprise SiC, which are capable of sustaining high voltages. The converter 106 can comprise a plurality of switching elements 116a and 116b that are configured to down convert the high DC voltage in the DC bus 105 down to DC voltages required by the battery 107. The switching elements 116a and 116b can comprise SiC devices that are capable of withstanding high voltage output from the DC bus. The advantage of this hybrid architecture can include the use of SiC devices in high voltage areas (for instance, voltage>650V) of the DC charging system and GaN devices for fast switching in low voltage areas (for instance, voltage<650V) of the DC charging system. Some implementations of the converter 106 can be configured to have additional switching elements. In such implementations, the switching elements can comprise GaN if the voltage at the switching elements is less than, for instance, 650V.

Without any loss of generality, Gallium Nitride (GaN) has almost 3× the electron mobility of Silicon Carbide (SiC), which means pure SiC architectures can only achieve up to 50 kHz in the state of the art, whereas GaN can achieve up to 1 MHz switching frequencies. Going from 50 kHz to 1 MHz enables shrinkage of bulky inductors, capacitors, and magnetics more than an order of magnitude from 8 μH down to 0.4 μH for inductors and down from over 600 μF down to 30 μF for capacitors. However, current SiC can handle higher voltages than GaN, thus implementations of the disclosed innovative hybrid architecture utilize the best of both materials.

The intelligent power management system 110 can be used to sense currents/voltages and/or temperature at various regions in the switching elements 112a, 112b, 112c, 116a, and 116b and adjust the driving voltages/currents that turn on/off the switching elements switching elements 112a, 112b, 112c, 116a, and 116b based on the sensed currents/voltages and/or temperature. In some implementations, the intelligent power management system 110 can infer the temperature of the switching elements 112a, 112b, 112c, 116a, and 116b based on the monitored current. In some implementations, the intelligent power management system 110 can also interface with the battery 108 and adjust the power output from the converter 106 based on the requirements of the battery 108. In various implementations, the intelligent power management system 110 can adjust the current and voltage provided to the battery based on the charging state of the battery 108. For example, the intelligent power management system 110 can provide a first current and a first voltage when the battery 108 is being charged from a low charge state (e.g., less than or equal to 30% charge) to a medium charge state (e.g., greater than about 30% charge and less than about 70% charge). The intelligent power management system 110 can provide a second current and a second voltage when the battery is being charged from the medium charge state to the high charge state (e.g., greater than or equal to about 70% charge).

The intelligent power management system 110 can include logic circuitry (which can be a processor) that controls a pulse width modulation (PWM) generator. The intelligent power management system 110 can comprise a neutral point controller configured to adjust the ground or neutral voltage of the AC voltage. In some implementations, the neutral point controller can provide reference voltage to the PWM generator. The PWM generator can produce one or more pulsed waveforms with adjustable frequency and duty cycle. The pulsed waveforms can be a square waveform in some implementations. Such one or more pulsed waveforms can be provided to control one or more of the switching elements (such as, 112a, 112b, 112c, 116a, or 116b) or rectifying diodes (such as, 114a, 114b, and 114c). For instance, a separate pulsed waveform can be generated to control each of the switching elements. In some cases, more than one PWM generators can be used. The DC voltage output from the DC-DC converter can be changed by changing one or more of the frequency or the duty cycle of the pulsed waveforms that drive or control one or more of the switching elements (such as, 112a, 112b, 112c, 116a, or 116b) or rectifying diodes (e.g., 114a, 114b, and 114c).

The PWM generator can be operated under control of the processor. Varying the frequency and duty cycle can impact the magnitude of the output DC voltage, efficiency (as well as other operational metrics) of the DC charging system. For instance, it may be desirable to limit the duration of time one or more amplifiers are on (or active) to limit the amount of lost energy (for instance, as a result of heat). At the same time, the frequency of switching to provide output power at a desired level may require the one or more amplifiers to be switched on frequently. As a result, there can be tradeoff between frequency and duty cycle to provide desired output power while maximizing efficiency. For instance, the frequency can be increased while the duty cycle can be decreased (or vice versa), The processor can utilize one or more AI or ML processes to control the PWM generator. In some cases, the processor can utilize one or more look-up table to determine the frequency and duty cycle of PWM signals for a particular combination of AC input power and desired output DC power. In some cases, the DC charging system can operate with at least 98% efficiency, about 0.95 to 0.99 (or more) power factor, and THD of less than about 5% (or less than about 3%).

In various implementations, the power management system 110 is configured to monitor power consumption and power requirement conditions of the battery 108 (for example, of an electric vehicle) and regulate the power supply based on the sensed conditions. As described herein, the power management system can include various sensors, switches, controllers, processors, etc. to sense, monitor and control various characteristics of the battery 108 and/or the charging circuit unit 100. The sensor system may include one or more temperature sensors, ultrasonic sensors, internet of things (IoT) sensors, optical sensors, biometric sensors, ultrasonic sensors, humidity sensors, etc.

The sensed data from the battery 108 and/or charging circuit unit 100 can be analyzed by the power management system 110 (for instance, with one or more processors). The sensed data can be used to determine various operational or physical characteristics. For example, based on the sensed operational conditions (e.g., temperature, input/output signal power, voltage/current at various terminals of the amplifier) of the charging circuit unit 100, the power management system 110 can control the current (or voltage) to turn one or more switches on or off or adjust the bias voltage of amplifiers, etc. Based on the sensed operational conditions of battery 108, the power management system 110 can regulate or adjust the power supply to the power storage system or one or more components or sub-components of the vehicle system.

In various implementations, the power management system 110 includes a processor (which can be part of a central computer) or is configured to communicate with an external processor. The processor can be connected to a memory that stores instructions configured to be executed by the processor. The instructions may include one or more classifiers. The classifier can be for example, battery profile classifier, user profile classifier, power requirement classifier, operational condition classifier, environmental and/or external condition classifier, vehicle classifier, component or subcomponent of the vehicle classifier, etc. The classifier can match the sensed conditions of battery 108 and/or charging circuit unit 100 in one or more classifiers look up table to provide the commands (or instructions) to the power management system. The one or more classifiers can include AI and/or ML processes to monitor, learn and classify the parameters and conditions of the circuit system 100 and battery 108. Based on the analyzed data the power management system changes or regulate various parameters of the charging circuit unit 100 and battery 108.

As disclosed herein, in various implementations, the power management system is configured to control multiple circuits, switches, and operating conditions based on the power requirement and power consumption conditions associated with the battery system (or vehicle charging system) and regulate the power supply. The power requirement conditions may include the amount of power supply required to charge the batteries, number of batteries, type of batteries, type of vehicle (car or truck or bike, etc.), power storage capacity, battery charging time, temperature conditions, or other operating conditions, etc. The power consumption conditions may include the amount of power consumed by the type of vehicle, amount of storage power required to the batteries, and power consumed in a time frame (e.g., in an hour, a day, a week or month,), etc. In some cases, the power requirement conditions may include conditions related to various components and sub-components of the vehicle or charging system. An example of various components can include vehicle motor, on-board charging components, air-conditioner (AC), heating system, battery, alternator, fan system, transmission system, etc. An example of various sub-components can include type of cells or batteries, dimensions, or size of batteries, charging requirements to media or auxiliary system, etc.

In some implementations, the processor can use AI and/or ML to monitor, learn, and classify the type of vehicles (e.g., truck or car or motor bike, year/make/model of vehicle), type of systems and/or sub-systems (type of motor, type of battery, size of battery, etc.). For example, the processor can use AI and/or ML to monitor, learn, and classify the profile of a battery or motor or auxiliary systems and can apply the power requirements (e.g., batter charging etc.) matching the type (or profile) of battery or motor or auxiliary system integrated in the type of vehicle. In some variations, AI and/or ML can be used to monitor, learn, and classify the health of components and/or sub-components of one or more vehicles. For example, monitoring the health status of a battery, identifying the health status with regards to the performance of battery and controlling the power level (or charging capacity) to the battery can be performed. Advantageously, monitoring the health status of components or sub-components and controlling the power requirements in devices, machines, or vehicles can be helpful to optimize the performance of the overall system.

In some implementations, the power management system 110 can monitor the health status of one or more components or sub-components of the vehicle and can prioritize the supply of power based on the health status. For example, in a case where there are several batteries installed in a vehicle, the power management system 110 can monitor the health (or battery profile) status of each battery among a group of batteries. The power management system 110 can accordingly prioritize to charge the weakest battery first in contrast to other batteries from the group. In some variations, the power management status can also monitor the material (or type) of battery (for example, Li-ion, NiMH, lead acid, or SiC) and based on the type of battery, the power supply can be adjusted and tuned to provide the necessary charging level. Therefore, the power management system 110 can monitor to optimize the power supply to at least some (or each) battery to provide the efficient distribution of power to various component or sub-components of the vehicle.

The intelligent power management system 110 can have multiple insertion points in the rectifier 103 and the converter 106 which can further reduce the size of the passive components (e.g., inductors/filters) and/or eliminate some of the passive components which can provide greater size and weight reduction. As discussed above, the intelligent power management system 110 can sense current/voltage at various points within the DC charger and track system characteristics including, but not limited to: temperature, performance, and power characteristics. The sensed data can be compiled and used for analytics. The intelligent power management system 110 can also monitor the health of the various devices in the rectifier 103 and the converter 106 and provide alerts of device failures.

In some implementations, the disclosed DC charger architecture can be employed to convert DC power to AC power. In other words, the systems illustrated in FIGS. 1 and 2A-2D can be used in reverse. For instance, such operation can be advantageous for allowing energy stored in the battery 108 to be fed back directly into the power grid (which can be represented by the AC main line 101). The intelligent power management system 110 can sense current/voltage at various points within the reversible DC charger and provide users opportunity to feed the battery energy back directly into the grid, which can be synchronized with the operation of the intelligent power management system 110.

FIG. 2C schematically illustrates an implementation of a DC charger (which can be similar to the DC charger illustrated in FIG. 2A) comprising a fast energy storage (or energy storage) 120. As is illustrated, the fast energy storage 120 can be connected to the DC bus 105. The fast energy storage 120 can be a booster or transient energy storage. Including of the fast energy storage 120 can advantageously allow power load transients to be supplied by an almost instantaneous (or instantaneous) energy reservoir instead of introducing disturbance into the grid, which in turn can improve power factor and THD. The fast energy storage 120 can advantageously reduce the THD to less than about less than about 5% (such as, less than or equal to about 3%) by providing energy quickly to handle transients or surges. This feature allows the AC input system (such as, the AC main line) 101 to be designed to provide a fixed or nearly fixed voltage which reduces THD. Fast energy storage 120 can be bidirectional in that power can flow from the grid to the fast energy storage 120 during no load transient intervals (for instance, in the AC main line), thereby charging the fast energy storage. Power can flow from the fast energy storage 120 to the battery 108 when there is a short overload transient condition (for instance, in the AC main line).

The fast energy storage 120 can include one or more of electrochemical capacitor(s) or battery(ies) that can be coupled to the DC bus 105 through a DC/DC converter. Power rating of the DC/DC converter can be only a small fraction of the total DC charger power rating. Although not illustrated in FIG. 2C, the DC charger can include the intelligent power management system 110 as shown in FIG. 2A. The intelligent power management system 110 can sense current/voltage at various points within the fast energy storage 120 and enable or disable provision of transient energy when power load transient is detected, as described herein.

Various implementations of DC chargers depicted in FIG. 2A can be configured to output between 10 kW-100 kW of DC power. This can advantageously simplify the design and reduce cost. However, several of the low power DC chargers configured to output between 10 kW-100 kW of DC power can be arranged in parallel as shown in FIG. 2D to generate high power DC chargers that are capable of providing DC power from about 150 kW to about 1000 kW. The number of rectifiers 103 that provide the input to the ‘n’ converters shown in FIG. 2D can be less than or equal to the number of the converters.

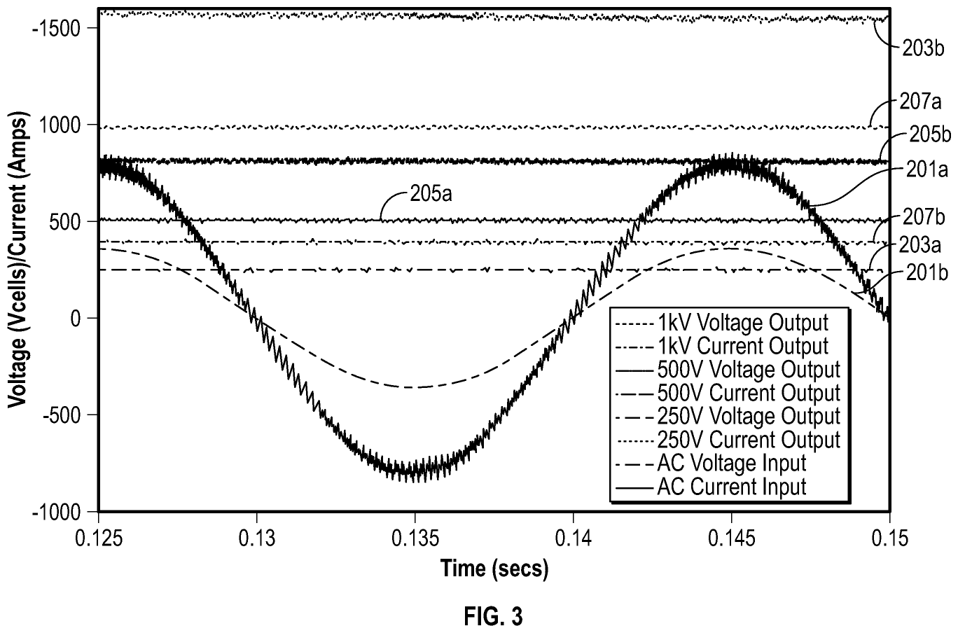

FIG. 3 depicts simulated results for a 400 kW DC charger that can provide DC voltages from 250V to about 1000V depending on the requirement of the battery. Curves 201a and 201b show the AC input voltage and current respectively. Curves 203a and 203b show the 250V DC output voltage and current respectively. Curves 205a and 205b show the 500V DC output voltage and current respectively. Curves 207a and 207b show the 1000V DC output voltage and current respectively.

As described herein, the systems and methods for providing the direct current (or voltage) charging solutions may use High electron mobility GaN hybrid architecture for ultra-compact, small footprint EV charging. The systems and methods described herein can offer intelligent bias power management systems configured to control GaN-based charging architecture that operates at rates up to 1 MHz (or up to 1.5 MHz in some cases). This can be quite efficient compared to existing state of the art solutions that provide electric vehicle switching rates at 50 kHz in pre-production units and 5 kHz in existing units with SiC.

Disclosed systems and methods may use intelligent power management systems (e.g., intelligent power management system 110 described above) to control the high-speed switches for transformer-less ultra-high efficient electrical vehicle charging. Among other advantages, an intelligent power management system can provide high power circuit isolation, full sensor integration, self-diagnostics to identify and resolve faults, enabling up to 98% (or greater) system efficiency. On the contrary, existing state of the art solutions claim efficiency level up to 98% for individual components, such as the AC/DC converter, but by cascading several 98% efficient components with a transformer, only achieve up to 94-96% efficiency at a system level. As such, present systems and methods provide overall efficiency to the system.

In various implementations, the intelligent power management system provides the feature of collecting user's data and/or vehicle data, data analysis, safety data, and/or health monitoring of components (or sub-components) and/or vehicle in general. In various implementations, the intelligent power management system provides the ability to directly sample and integrate data from sensors throughout the DC charger. Each device can be Internet-connected and compile that data to provide comprehensive information to users and charging station providers. It is through this information that charging providers can track user trends, increase user satisfaction, optimally (re)distribute resources, and minimize system outages.

Disclosed systems and method can provide optimized scalable voltage output from about 50V to 10 kV with less than about 5% or (less than about 3%) THD. Intelligent power management technology can provide control for scalable voltage outputs to meet the requirements of heterogeneous battery architectures while also maintaining extremely low THD (such as, less than about <3%).

Disclosed systems and methods can analyze the sensed current. For example, it is possible to sense if there is a load connected to the DC charger, what is the current waveform, measure harmonic spectrum, or the like. Gate voltage of the switching devices (for instance, GaN) can be optimized for maximum switching efficiency. Processor of the intelligent power management system can operate control loops at high speeds (such as, 100 MHz), thereby enabling DC chargers to be smaller and faster. Switching frequencies of the switching devices can be adjusted during operation, thereby allowing generating a variety of DC voltages from about 50V (or less) to 10 kV (or more). One or more logic processes can be utilized to increase efficiencies of power transfer (such as, maximizing matching of power transfer harmonics between source and load). Disclosed systems and method can be programmable so that DC output voltage can be changed dynamically responsive to inputs from a user or external computing system(s).

### Other Variations

Although certain examples described herein include Gallium Nitride (GaN) switches and silicon carbide (SiC) rectifying diodes, switches other than GaN and diodes other than SiC can be used. Although certain examples refer to the use of field-effect transistors (FETs) as switching devices, other transistor types can be used, such as bipolar junction transistors (BJTs) or insulated-gate bipolar transistors (IGBTs).

Features, materials, characteristics, or groups described in conjunction with a particular aspect, embodiment, or example are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some embodiments, the actual steps taken in the processes disclosed and/or illustrated may differ from those shown in the figures. Depending on the embodiment, certain of the steps described above may be removed, others may be added. For example, the actual steps and/or order of steps taken in the disclosed processes may differ from those described and/or shown in the figure. Depending on the embodiment, certain of the steps described above may be removed, others may be added. For instance, the various components illustrated in the figures and/or described may be implemented as software and/or firmware on a processor, controller, ASIC, FPGA, and/or dedicated hardware. Furthermore, the features and attributes of the specific embodiments disclosed above may be combined in different ways to form additional embodiments, all of which fall within the scope of the present disclosure.

In some cases, there is provided a non-transitory computer readable medium storing instructions, which when executed by at least one computing or processing device, cause performing any of the methods as generally shown or described herein and equivalents thereof.

Any of the memory components described herein can include volatile memory, such random access memory (RAM), dynamic random access memory (DRAM), synchronous dynamic random access memory (SDRAM), double data rate (DDR) memory, static random access memory (SRAM), other volatile memory, or any combination thereof. Any of the memory components described herein can include non-volatile memory, such as magnetic storage, flash integrated circuits, read only memory (ROM), Chalcogenide random access memory (C-RAM), Phase Change Memory (PC-RAM or PRAM), Programmable Metallization Cell RAM (PMC-RAM or PMCm), Ovonic Unified Memory (OUM), Resistance RAM (RRAM), NAND memory (e.g., single-level cell (SLC) memory, multi-level cell (MLC) memory, or any combination thereof), NOR memory, EEPROM, Ferroelectric Memory (FeRAM), Magnetoresistive RAM (MRAM), other discrete NVM (non-volatile memory) chips, or any combination thereof.

Any user interface screens illustrated and described herein can include additional and/or alternative components. These components can include menus, lists, buttons, text boxes, labels, radio buttons, scroll bars, sliders, checkboxes, combo boxes, status bars, dialog boxes, windows, and the like. User interface screens can include additional and/or alternative information. Components can be arranged, grouped, displayed in any suitable order.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, or within less than 0.01% of the stated amount.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations.

The foregoing description, for purposes of explanation, used specific nomenclature to provide a thorough understanding of the disclosure. However, it will be apparent to one skilled in the art that specific details are not required in order to practice the disclosed embodiments. Thus, the foregoing descriptions of specific embodiments are presented for purposes of illustration and description. They are not intended to be exhaustive or to limit the disclosure to the precise forms disclosed; obviously, many modifications and variations are possible in view of the above teachings. The embodiments were chosen and described in order to best explain the principles of the disclosure and its practical applications, they thereby enable others skilled in the art to best utilize the disclosure and various embodiments with various modifications as are suited to the particular use contemplated. It is intended that the claims as presented herein or as presented in the future and their equivalents define the scope of the protection.

What is claimed is:

1. A direct current (DC) charging system configured to charge a battery, the system comprising:
a rectifier comprising:
a plurality of Gallium Nitride (GaN) switches; and
a plurality of silicon carbide (SiC) rectifying diodes,
wherein the rectifier is configured to receive alternative current (AC) input and output a first DC signal; and
a converter configured to convert the first DC signal into a second DC signal that meets charging needs of a battery, wherein the converter comprises a plurality of SiC switches, and wherein the second DC signal is provided to the battery for charging the battery.

2. The DC charging system of claim 1, wherein the plurality of GaN switches are disposed in one or more locations of the rectifier configured to operate at a voltage equal to or below a voltage threshold, and wherein the plurality of SiC rectifying diodes are disposed in one or more locations of the rectifier configured to operate at a voltage above the voltage threshold.

3. The DC charging system of claim 2, wherein the voltage threshold is between about 500V and about 700V.

4. The DC charging system of claim 1, further comprising a DC bus connected to the rectifier and the converter.

5. The DC charging system of claim 1, further comprising a power management system configured to interface with the rectifier and the converter, wherein the power management system is configured to sense at least one of currents or voltages at various portions of the plurality of GaN switches and adjust a plurality of signals configured to turn on or turn off the plurality of GaN switches based on the sensed at least one of currents or voltages.

6. The DC charging system of claim 5, wherein the power management system is further configured to sense the at least one of currents or voltages at various portions of the plurality of SiC switches and adjust a plurality of signals configured to turn on or turn off the plurality of SiC switches based on the sensed at least one of currents or voltages.

7. The DC charging system of claim 5, wherein the power management system comprise a pulse width modulation (PWM) generator and a processor configured to control the PWM generator to generate a plurality of driving signals to control the plurality of GaN switches.

8. The DC charging system of claim 7, wherein the processor is configured to determine a tradeoff between a frequency and duty cycle of at least one driving signal of the plurality of driving signals to achieve a desired efficiency or a desired output DC voltage.

9. The DC charging system of claim 8, wherein the power management system is configured cause the second DC signal to be adjusted based on an input from a user or an external computing system, wherein the second DC signal is adjusted as a result of adjusting the frequency or duty cycle of the at least one signal of the plurality of signals.

10. The DC charging system of claim 9, wherein the input comprises one or more digital control signals.

11. The DC charging system of claim 5, wherein the power management system is further configured to adjust switching frequencies of the plurality of SiC or GaN switches based on an output voltage required by the battery.

12. The DC charging system of claim 5, wherein the power management system is further configured to monitor health of at least one of the plurality of GaN switches or the SiC switches.

13. The DC charging system of claim 5, wherein the power management system is further configured to collect data related to health and operating status of at least one of the plurality of GaN switches or the SiC switches.

14. The DC charging system of claim 1, wherein the converter is configured as a DC-DC converter.

15. The DC charging system of claim 1, wherein the converter does not include a transformer.

16. The DC charging system of claim 1, wherein the rectifier is configured to output the first DC signal between about 500V and about 1500V.

17. The DC charging system of claim 1, wherein the converter is configured to output the second DC signal in a range between 50V and 10 kV to the battery.

18. A direct current (DC) charging system configured to charge a battery, the system comprising:
a rectifier comprising:
a plurality of Gallium Nitride (GaN) switches; and
a plurality of silicon carbide (SiC) rectifying diodes,
wherein the rectifier is configured to receive alternative current (AC) input and output a first DC signal;
a converter configured to convert the first DC signal into a second DC signal that meets charging needs of a battery, wherein the converter comprises a plurality of SiC switches; and
a power management system configured to monitor and control one or more operating conditions of at least one of the rectifier or converter.

19. The DC charging system of claim 18, wherein the power management system is configured to monitor the one or more operating conditions and modulate supply voltage or current to at least one of the rectifier or converter.

20. The DC charging system of claim 18, wherein the one or more operating conditions comprise at least one of: a temperature of at least one of the rectifier or converter, currents or voltages at various terminals of at least one the rectifier or converter, gate voltage of at least one GaN switch, timing of switching on and off the at least one GaN switch, or bias voltage provided to the at least one GaN switch.
